(19) United States
(12) Patent Application Publication
(10) Pub. No.: US 2010/0251104 A1
(43) Pub. Date: Sep. 30, 2010

(54) SYSTEM AND METHOD FOR REFLOWING CONTENT IN A STRUCTURED PORTABLE DOCUMENT FORMAT (PDF) FILE

(75) Inventor: Deepak Massand, McLeansville, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Litera Technology LLC., McLeansville, NC (US)

(21) Appl. No.: 12/413,486

(22) Filed: Mar. 27, 2009

(51) Int. Cl. G06F 17/00

(52) U.S. Cl. 715/249

(57) ABSTRACT

A system, method and computer program product for the reflowing of content in a structured portable document format (PDF) document in its native format, including an application for adding and/or deleting content in the PDF document; a reflow mechanism in communication with the application and configured for reflowing content immediately following the added and/or deleted content until the end of the document. The reflowing for the added content includes shifting existing content after the added content to a physical location in the document immediately following the added content, and the reflowing for the deleted content includes shifting existing content after the deleted content to a physical location in the document to where the deleted content was originally located; and displaying the resulting document. The adding and/or deleting of the content and the reflowing of the content are performed while the document is maintained in its native format.

### BACKGROUND OF THE INVENTION

1. Field of the Invention

The present invention relates generally to systems and methods for editing of files, and more particularly to an automated system and method for adding and/or deleting content, including graphics, text, design elements, such as carriage returns, and the like, and reflowing the existing content after the added and/or deleted content within a structured layout of a portable document format (PDF) file.

2. Discussion of the Background

A page description language (PDL) is a computer language that specifies the arrangement of a printed page. PDLs enable computer users to create non-graphical documents that maintain the creators' fonts, colors, formatting and graphics when viewed by a recipient, regardless of the type of software, computer system or other viewing device operated by the recipient. Documents created using PDLs have become ubiquitous and are used by individuals engaged in multiple industries and for various pursuits. Two common PDLs are Postscript™, developed by Adobe Systems, Inc, and Printer Control Language™, developed by Hewlett Packard. Documents created with PDLs are presented through certain graphical elements (e.g., such as lines, arcs and geometrical shapes) as opposed to bitmapping each point in a document. One well known document format created in PDL is the portable document format (PDF), a document type created by Postscript.

Conventional methods and systems enable documents to be created, edited and modified in PDF editing programs, such as Adobe Acrobat™. However, conventional methods and systems, while providing for the retention of style and structure (e.g., fonts, layouts, various graphical elements) across computer systems, rarely allow for editing capacity outside of the original, initial computer program that designed the project and only when the initial, raw, unprocessed file created by a program using the original PDF is accessible. There are exceptions. For example, techniques employed by Adobe Systems, Inc, for example, enable columns within PDF documents to be resized and for text and graphical elements within those documents to, therein, be reflowed through the document in reflection of the change made to the column's width and/or height. This provides for the capacity to make substantial document changes outside of the unprocessed file. The provision of such editing capacity allows for portable documents that are able to better be used by a multiplicity of users with broad and various needs. What is currently lacking in conventional methods and systems, however, is a technique to give document creators and reviewers the ability to add and delete content, which can be graphics, text, design elements, such as carriage returns, and the like, in a PDF document, and maintain the structure and integrity of the modified PDF document.

### SUMMARY OF THE INVENTION

Embodiments of the invention provide an improved method and system that allows users to reflow content in a structured portable document format (PDF) document in its native format. Users that access PDF documents within the application can then add and/or delete content, including graphics, text, design elements, such as carriage returns, and the like, directly into the PDF document while the document is in its native format. Existing content will then reflow to subsequent lines, paragraphs, text blocks and pages in the case of an addition of content or the preceding physical location and then throughout the document in the case of a deletion of content.

Accordingly, in an exemplary aspect of the present invention there is provided a method, system and computer program product for the reflowing of content in a structured portable document format (PDF) document in its native format, including an application for adding and/or deleting content in the PDF document; a reflow mechanism in communication with the application and configured for reflowing content immediately following the added and/or deleted content until the end of the document. The reflowing for the added content includes shifting existing content after the added content to a physical location in the document immediately following the added content, and the reflowing for the deleted content includes shifting existing content after the deleted content to a physical location in the document to where the deleted content was originally located; and displaying the resulting document. The adding and/or deleting of the content and the reflowing of the content are performed while the document is maintained in its native format.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

Embodiments of the present invention are illustrated by way of example, and not by way of limitation, in the figures of the accompanying drawings, which are included to provide a further understanding of the invention and are incorporated in and constitute a part of this specification. In the drawings:

FIG. 1 is a block diagram of an exemplary computing system for displaying, modifying and reflowing content in a portable document format (PDF) document;

FIG. 2A depicts a paragraph in a PDF page before and after the addition of content that results in content reflow changes at the paragraph level;

FIG. 2B depicts a paragraph in a PDF page before and after the deletion of content that results in content reflow changes at the paragraph level;

FIG. 3A depicts a text block in a PDF page before the addition of content that results in content reflow changes at the columnar level;

FIG. 3B depicts a text block in a PDF page after the addition of content that results in content reflow changes at the columnar level;

FIG. 4A depicts a text block in a PDF page before the deletion of content that results in content reflow changes at the columnar level;

FIG. 4B depicts a text block in a PDF page after the deletion of content that results in content reflow changes at the columnar level;

FIG. 5A depicts a two-column PDF page before the addition of content that results in content reflow changes at the page level;

FIG. 5B depicts a two-column PDF page after the addition of content that results in content reflow changes at the page level;

FIG. 6A depicts a two-column PDF page before the deletion of content that results in content reflow changes at the page level;

FIG. 6B depicts a two-column PDF page after the deletion of content that results in content reflow changes at the page level;

FIG. 7A depicts a multiple-page PDF document before the addition of content that results in content reflow changes at the document level;

FIG. 7B depicts a multiple-page PDF document after the addition of content that results in content reflow changes at the document level;

FIG. 8A depicts a multiple-page PDF document before the deletion of content that results in content reflow changes at the document level;

FIG. 8B depicts a multiple-page PDF document after the addition of content that results in content reflow changes at the document level;

FIG. 9A depicts a text block in a PDF page in which the addition of content and subsequent content reflow requires the hyphenation of text that has been reflowed to the right margin of the text block;

FIG. 9B depicts a text block in a PDF page in which the deletion of content and subsequent content reflow requires the hyphenation of text that has been reflowed to the right margin of the text block;

FIG. 10 is a flowchart depicting the process by which the exemplary system and method reflows content in a structured PDF document; and

FIG. 11 is a flowchart depicting an exemplary process for the content reflow mechanism when new content is added.

FIG. 12 is a flowchart depicting an exemplary process for the content reflow mechanism when existing content is deleted.

### DETAILED DESCRIPTION

The various aspects are described hereafter in greater detail in connection with a number of exemplary embodiments to facilitate an understanding of the invention. However, the invention should not be construed as being limited to these embodiments. Rather, these embodiments are provided so that the disclosure will be thorough and complete, and will fully convey the scope of the invention to those skilled in the art.

The invention includes recognition that conventional methods and systems provide for mechanisms to reflow text. However, these systems and methods require that editors of content work in document formats created in specific document design applications and not in native portable document format (PDF). In addition, the invention recognizes that conventional systems provide for multiple methods and techniques to edit content in native PDF documents; however, these methods and techniques do not provide for a mechanism to ensure the proper reflow of text throughout the native PDF document.

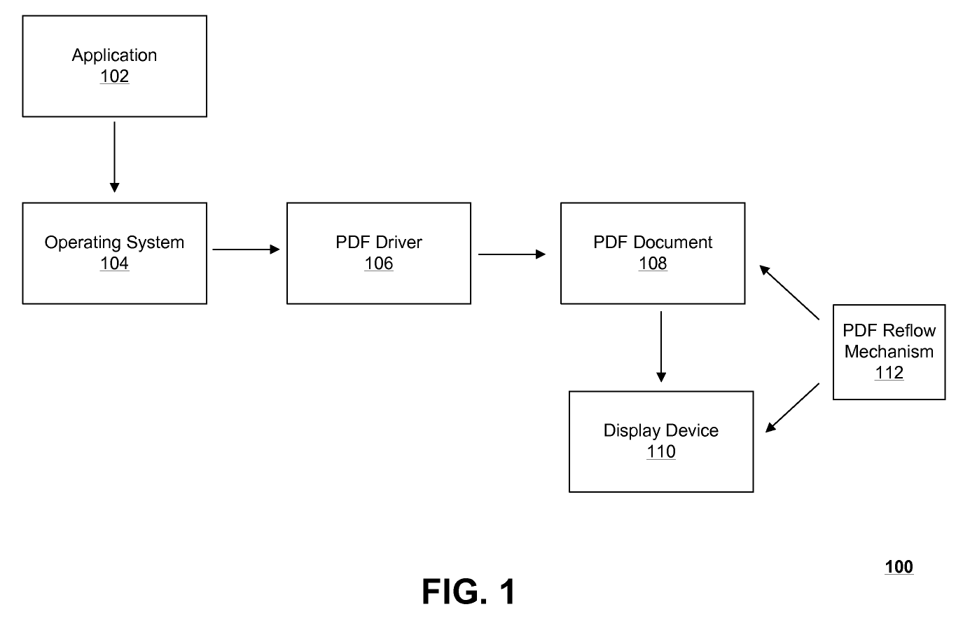

Referring now to the drawings, wherein like reference numerals designate identical or corresponding parts throughout the several views, and more particularly to FIG. 1 thereof, there is illustrated an exemplary computing system 100 for displaying, modifying and reflowing content in a portable document format (PDF) document. In FIG. 1, the system 100 includes an application 102 that displays a PDF document in the environment of an operating system 104. The document is displayed via the capacity of the application's PDF driver 106, which registers data in the PDF document and presents the data accordingly as a PDF document 108 on a display device 110. A PDF reflow mechanism 112 is provided to then enable users to add and/or delete content to the existing PDF document 108, in which all content after the added or deleted content is reflowed throughout and until the end of that document 108, and redisplayed on the display device 110.

The exemplary embodiments described herein, advantageously, can change the location and presentation of content in a PDF document, in a word, line, paragraph, text block, column, page and document level, and the like. The PDF reflow mechanism 112 enables users to open a PDF document in its native format and provide for the adding and deleting of content in the PDF document and reflowing existing content in the PDF document while the PDF document is still in its native format, advantageously, without the need for exporting the PDF document to another document format to allow for the adding and deleting of the content and reflowing.

In further exemplary embodiments, multiple variations in presentation and reflow of content can be provided for, based on the teachings of the present invention, as will be appreciated by those skilled in the relevant art(s).

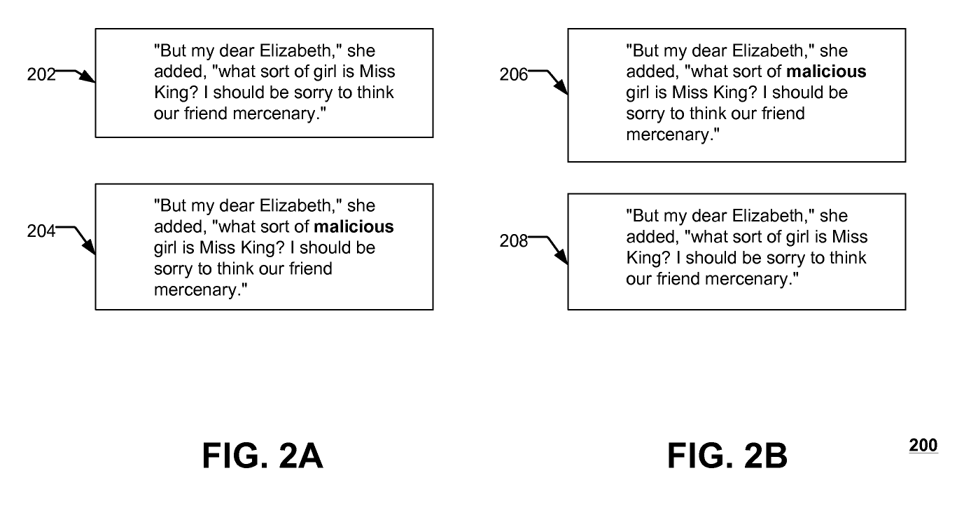

FIGS. 2A and 2B show examples of changes made to content that result in the reflow of content at a paragraph level. In FIGS. 2A and 2B, a paragraph 202 is shown in a PDF document page prior to the addition of new content. The word “malicious” (shown in bold text) is added to the paragraph 202, causing the content after the added word (“girl is Miss King? I should be . . . .”) to be reflowed by the PDF reflow mechanism 112 to the physical space following the added word, as shown in paragraph 204. Paragraph 206 is shown in a PDF document page prior to the deletion of content. The word “malicious” (shown in bold text in paragraph 206) is deleted from paragraph 206, causing the content after the deleted word to be reflowed by the PDF reflow mechanism 112 to the physical space in the PDF document following the added content.

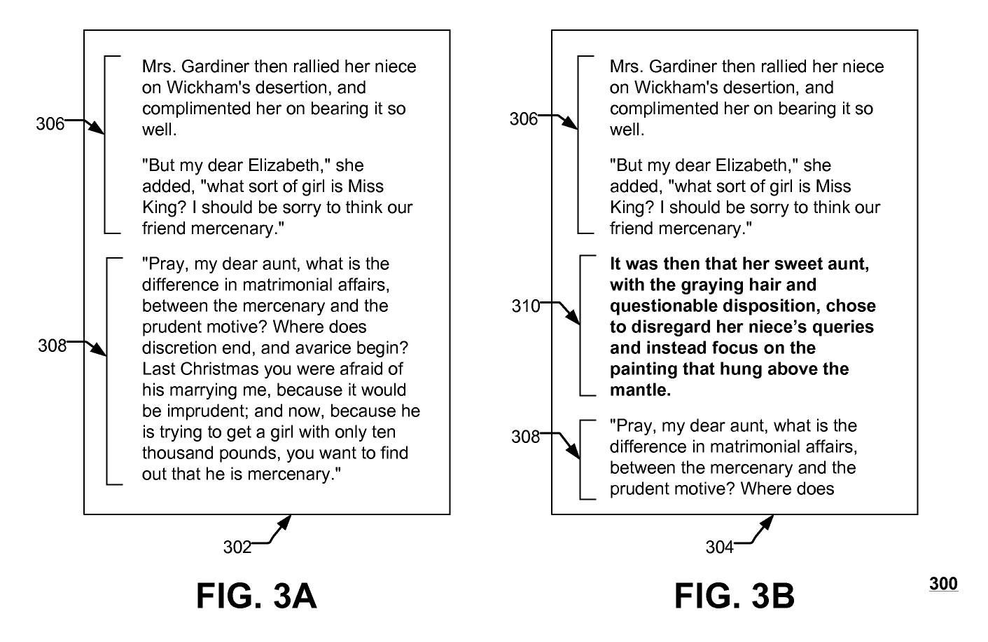

FIGS. 3A and 3B show an example of changes made to content that result in the reflow of content at the columnar level. In FIG. 3A, a column of content 302 is shown in a PDF document page prior to the addition of new content. Content in the column is split into two distinct content regions 306 and 308. The phrase “It was then that her sweet aunt . . . ” (shown in bold text), shown here as content region 310, is added to the column 302 between content region 306 and 308, causing the content after the added content region 310 to be reflowed by the PDF reflow mechanism 112 to the physical space in the PDF document following the added content.

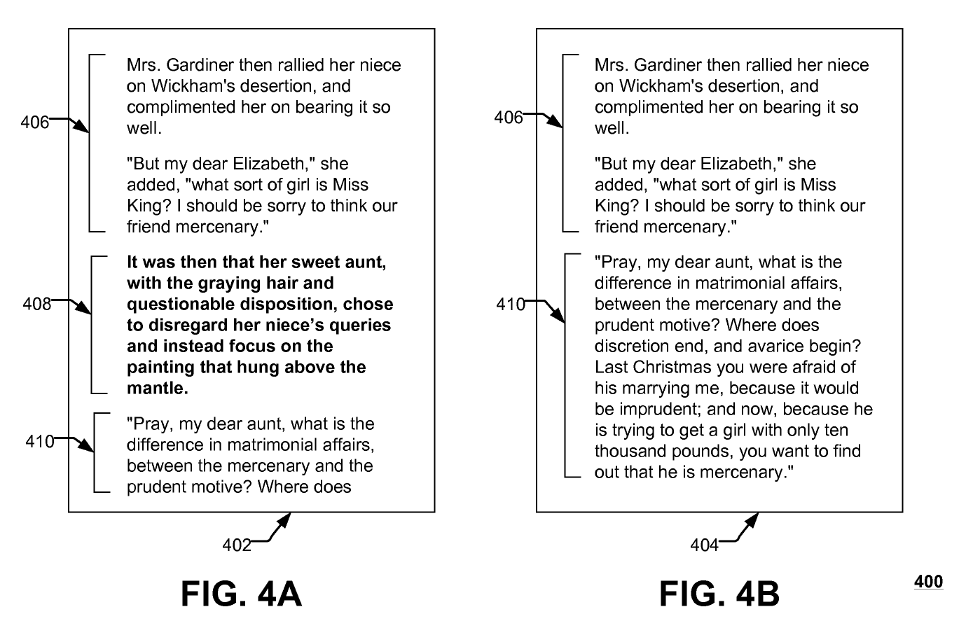

FIGS. 4A and 4B show an example of changes made to content that result in the reflow of content at the columnar level. In FIG. 4A, a column of content 402 is shown in a PDF document page prior to the deletion of existing content. Content in the column is split into three distinct content regions 406, 408 and 410. The phrase “It was then that her sweet aunt . . . ” (shown in bold text), shown here as content region 408, is deleted from the column 402, causing the content after the deleted content region 410 to be reflowed by the PDF reflow mechanism 112, so that the content following the deleted content region 408 reflows to the preceding physical location in the PDF document and continues reflowing thusly throughout the document.

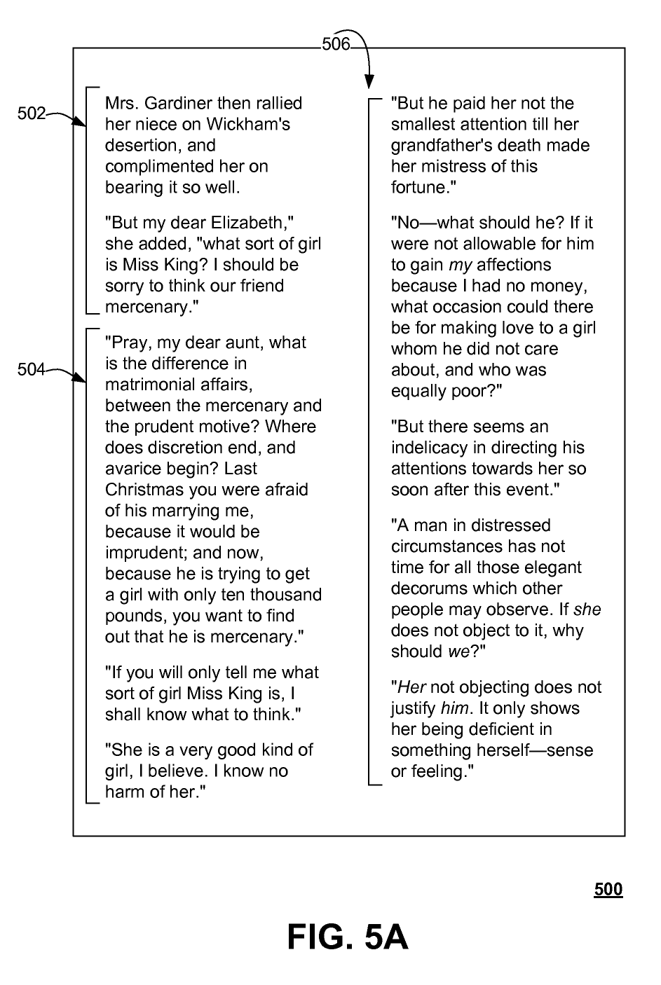

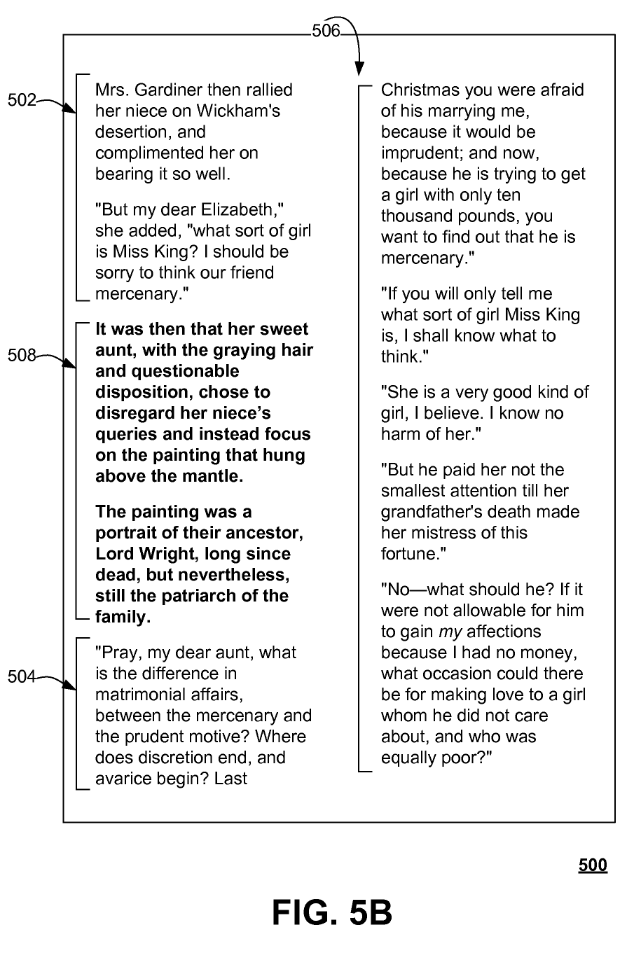

FIGS. 5A and 5B show an example of changes made to content that results in the reflow of content at the page level. In FIG. 5A, a page of content 500 is shown in a PDF document page prior to the addition of new content. Content on the page is split into three distinct content regions 502, 504 and 506. The phrase “It was then that her sweet aunt . . . ” (shown in bold text), shown here as content region 508, is added to the page 500 between content region 502 and 504, causing the content after the added content region 508 to be reflowed by the PDF reflow mechanism 112 to the physical space in the PDF document following the added content, as shown in page 500.

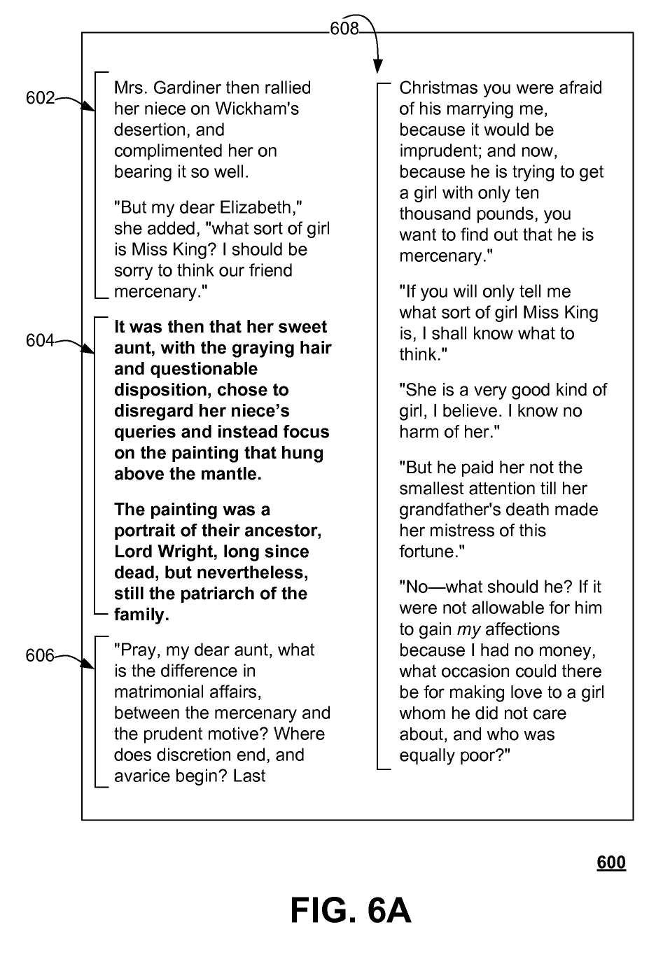

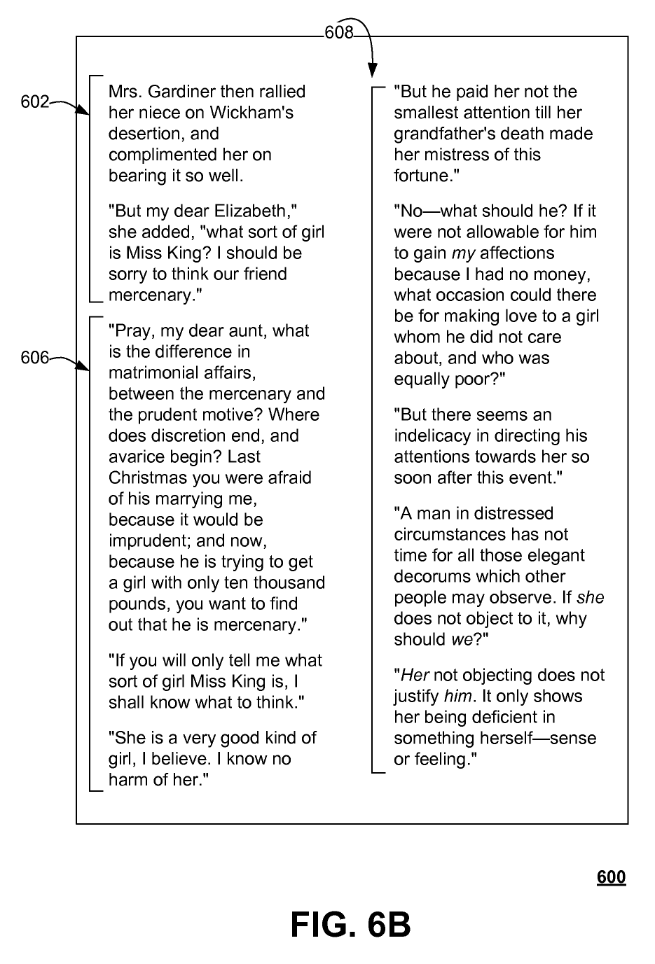

FIGS. 6A and 6B show an example of changes made to content that result in the reflow of content at the page level. In FIG. 6A, a page of content 600 is shown in a PDF document page prior to the deletion of existing content. Content on the page is split into four distinct content regions 602, 604, 606 and 608. The phrase “It was then that her sweet aunt . . . ” (shown in bold text), shown here as content region 604, is deleted from the page 600, causing the content after the deleted content to be reflowed by the PDF reflow mechanism 112, so that the content following the deleted content reflows to the preceding physical location in the PDF document and continues reflowing thusly throughout the document.

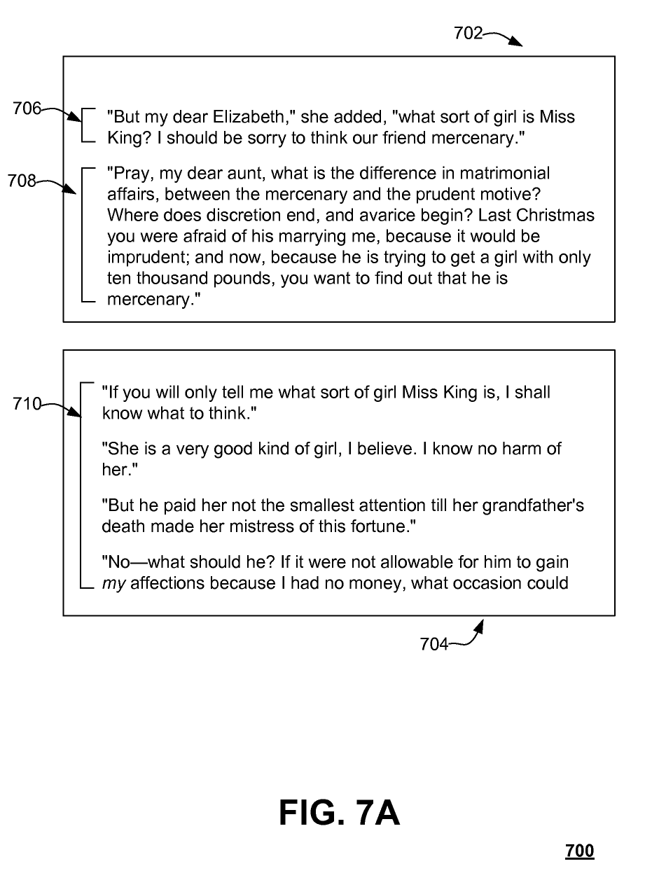

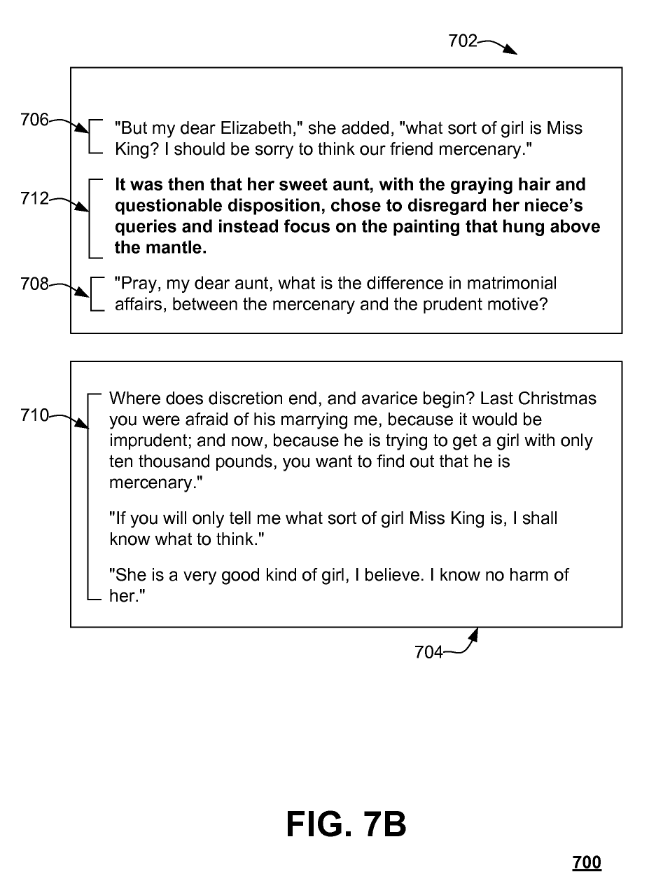

FIGS. 7A and 7B show an example of changes made to content that result in the reflow of content at the document level. In FIGS. 7A and 7B, two pages 702 and 704 are shown in a PDF document prior to the addition of new content. In Page 702, two content regions 706 and 708 are presented. In Page 704, one additional content region 710 is presented. The phrase “It was then that her sweet aunt . . . ” (shown in bold text) shown here as content region 712, is added to the page 702 between content region 706 and 708, causing the content after the added content region 712 to be reflowed by the PDF reflow mechanism 112 to the physical space in the PDF document following the added content, as shown in pages 702 and 704.

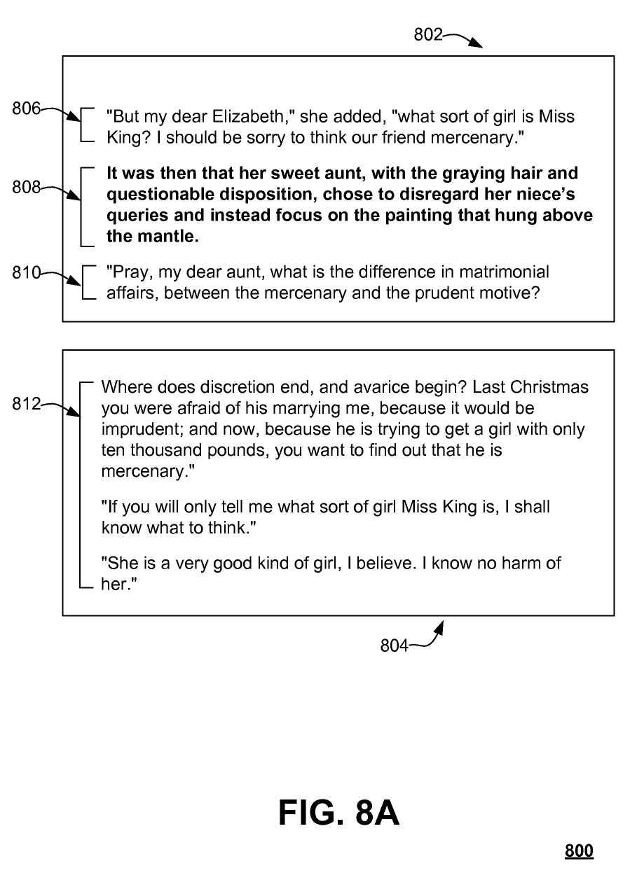

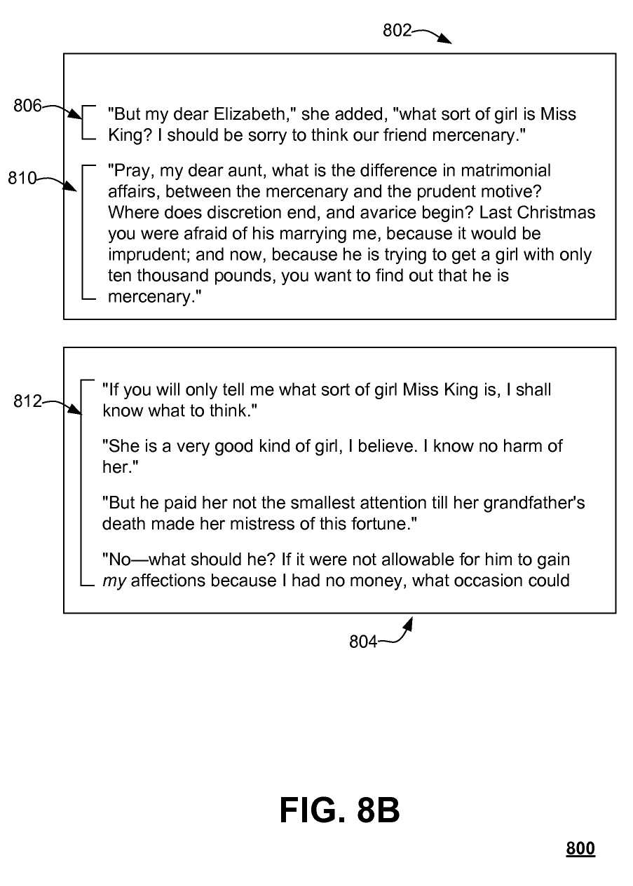

FIGS. 8A and 8B show an example of changes made to content that result in the reflow of content at the document level. In FIGS. 8A and 8B, two pages 802 and 804 are shown in a PDF document prior to the deleting of existing content. In page 802, three content regions 806, 808 and 810 are presented. In page 804, one additional content region 812 is presented. The phrase “It was then that her sweet aunt . . . ” (shown in bold text) shown here as content region 808, is deleted from page 802 between content regions 806 and 810, causing the content after the deleted content to be reflowed by the PDF reflow mechanism 112, so that the content following the deleted content reflows to the preceding physical location in the PDF document and continues reflowing thusly throughout the document.

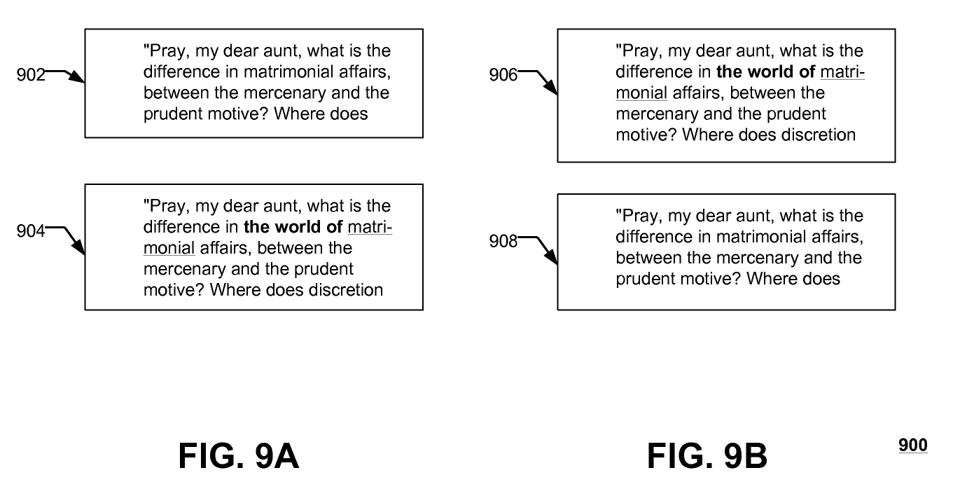

FIGS. 9A and 9B show examples of changes made to content that result in the reflow of content at the line level where the hyphenation of text that has been reflowed to at and beyond the right margin of a text block occurs. In FIGS. 9A and 9B, a paragraph 902 is shown in a PDF document page prior to the addition of new content. The words “in the world of” (shown in bold text) are added to the paragraph 902, causing the content after the added words (matrimonial affairs . . . ) to be reflowed by the PDF reflow mechanism 112 to the physical space following the added words, as shown in paragraph 904. In the reflow process, the word “matrimonial” has been reflowed so that it has shifted at and beyond the right margin of the text block. Instead of being reflowed to the following line, the word is hyphenated so that one or multiple syllables remain on the existing line and one or multiple syllables flow to the following line, these syllables separated by a hyphen. Paragraph 906 is shown in a PDF document prior to the deletion of content. The words “the world of” (shown in bold text in paragraph 906 are deleted from paragraph 906, causing the content after the deleted words to be reflowed by the PDF reflow mechanism 112 to the preceding physical location in the PDF document and continues reflowing thusly throughout the document. The previously hyphenated word “matrimonial,” through the reflow process, has shifted to a physical space within the right margin of the paragraph, and, therefore, the hyphen that separated the word in paragraph 906 is removed, as shown in paragraph 908.

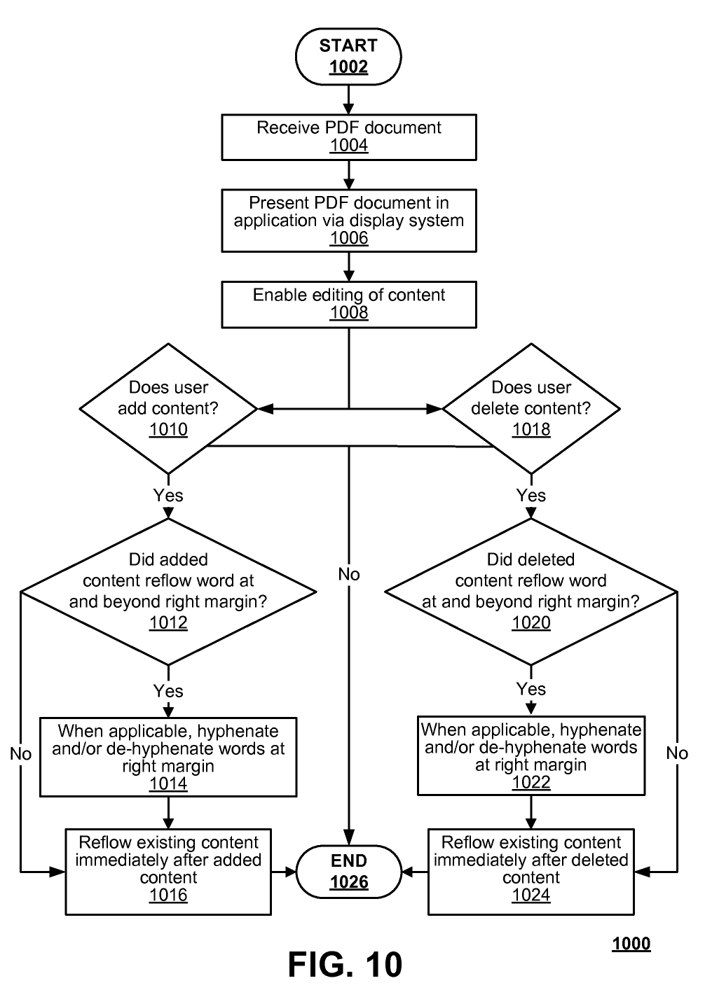

FIG. 10 is a flowchart depicting an exemplary process 1000 by which the exemplary system and method reflows content in a structured PDF document. In FIG. 10, the exemplary process starts at step 1002, and at step 1004 a PDF document is received. The PDF document is then presented at step 1006 in an application 102 via a display system 110 and the editing of content is enabled at step 1008. The user is then able to place their cursor anywhere within content regions in the document and begin adding new content or deleting existing content. If the user adds content at step 1010, the content following the added content is then reflowed to subsequent lines, paragraphs, text blocks and pages at step 1016 by the PDF reflow mechanism 112. If words in the following content regions, due to the reflowing of content, are shifted to and beyond the right margin of the content area and have multiple syllables, identified at step 1012, the words are hyphenated so that one or multiple syllables of the word remain in the edited line and one or multiple syllables of the word flow to the following line at step 1014. If words that were previously hyphenated due to the fact that they were located at and beyond the right margin of the content region are no longer located in a region in which they need to be hyphenated, these words are de-hyphenated. If the user deletes content at step 1018, the content following the deleted content is reflowed to the preceding physical location and continues reflowing thusly throughout the document at step 1024 by the PDF reflow mechanism 112. If words in the content regions following the deleted content, due to the reflowing of content, are shifted to and beyond the right margin of the content area and have multiple syllables, identified at step 1020, the words are hyphenated so that one or multiple syllables of the word remain in the edited line and one or multiple syllables of the word flow to the following line at step 1022. If words that were previously hyphenated due to the fact that they were located at and beyond the right margin of the content region are no longer located in a region in which they need to be hyphenated, these words are de-hyphenated at step 1022. Once the content has been reflowed by the PDF reflow mechanism 112 and displayed to the user via a display system 110, the process ends at step 1026.

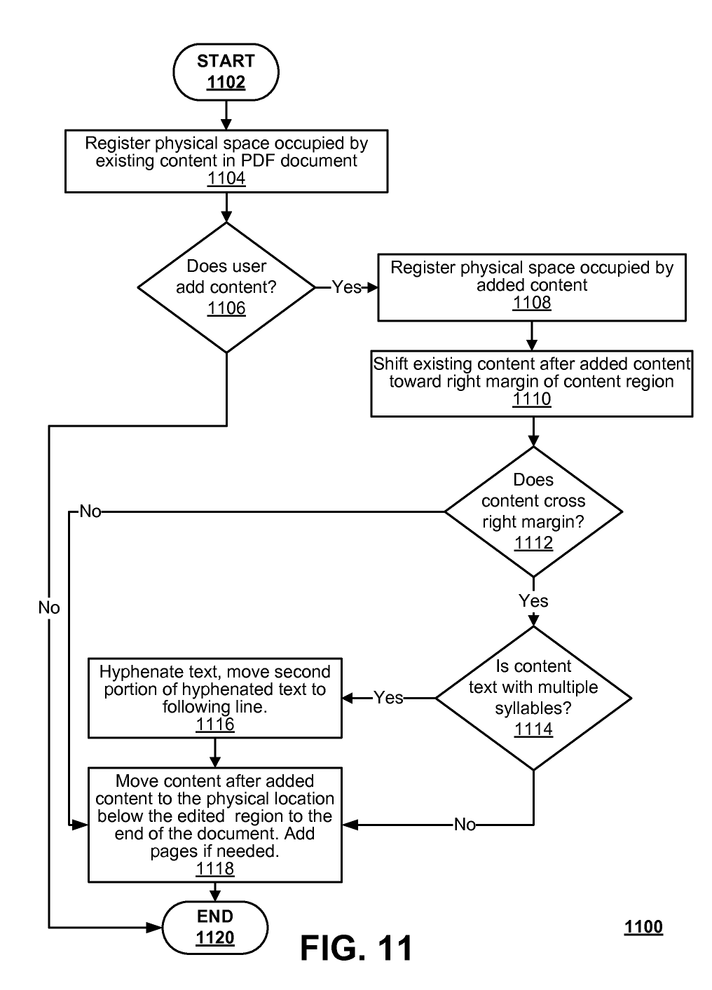

FIG. 11 is a flowchart depicting an exemplary process 1100 for the content reflow mechanism when new content is added. In FIG. 11, the exemplary process starts at step 1102, and at step 1104, the physical space occupied by the existing content in the PDF document is identified. If the user adds content at step 1106, the exemplary system registers the physical space in the PDF document occupied by the added content in step 1108 and shifts the existing content after the added content toward the right margin of the content region in which the content was added in step 1110. If the content crosses the right margin of the content region in step 1112, the exemplary process registers whether the content that crossed the right margin is a word with multiple syllables in step 1114. If the content is a word with multiple syllables, that particular word is hyphenated, so that one or multiple syllables remain on the current line (up to but not beyond the right margin) and the remaining one or multiple syllables shift to the following line, and are separated by a hyphen that does not cross the right margin of the content region at step 1116. After all the hyphenation takes place, all additional content moves to the following line and lines in a content region and continues to flow, where relevant, to the following column and/or page of the document until the end of the document in step 1118. If content reflows to the beyond the bottom content region margin of the final page of the document, an additional page and/or pages is dynamically created and the content that flowed beyond the bottom margin of the bottom content region is placed on the newly created page and/or pages.

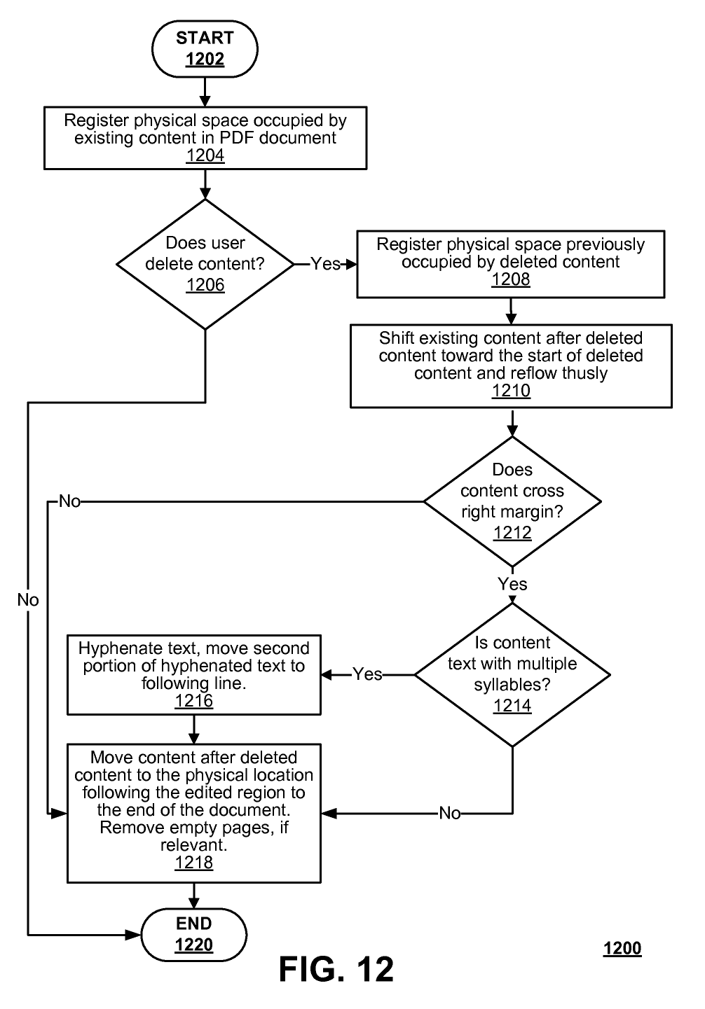

FIG. 12 is a flowchart depicting an exemplary process 1200 for the content reflow mechanism when existing content is deleted. In FIG. 12, the exemplary process starts at step 1202, and at step 1204, the physical space occupied by the existing content in the PDF document is identified. If the user deletes content at step 1206, the exemplary system registers the physical space in the PDF document previously occupied by the deleted content in step 1208 and shifts the existing content after the deleted content toward the start of the deleted content's original location and reflows content in the document thusly in step 1210. If, due to this shift in content, any content crosses the right margin of the content region in step 1212, the exemplary process registers whether the content that crossed the right margin is a word with multiple syllables in step 1214. If the content is a word with multiple syllables, that particular word is hyphenated, so that one or multiple syllables remain on the current line (up to but not beyond the right margin) and the remaining one or multiple syllables shift to the following line, and are separated by a hyphen that does not cross the right margin of the content region at step 1216. After all the hyphenation takes place, all additional content moves to the following line and lines in a content region and continues to flow, where relevant, to the following column and/or page of the document until the end of the document in step 1218. If, through the process of reflowing content, a final page in the document is left blank (with no content), that final page will be removed by the exemplary process.

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of the appended claims.

What is claimed is:

1. A computer implemented method for the reflowing of content in a structured portable document format (PDF) document in its native format, the method comprising:
adding and/or deleting content in the PDF document;
reflowing content immediately following the added and/or deleted content until the end of the PDF document,
wherein the reflowing for the added content includes shifting existing content after the added content to a physical location in the PDF document immediately following the added content, and
the reflowing for the deleted content includes shifting existing content after the deleted content to a physical location in the PDF document to where the deleted content was originally located; and
displaying the resulting PDF document,
wherein the steps of adding and/or deleting of the content and the reflowing of the content are performed while the PDF document is maintained in its native format.

2. The method of claim 1, wherein the reflowing step for the added content includes causing existing content to reflow to at least one of subsequent lines, paragraphs, text blocks and pages, and
when the existing content reflows to a physical location beyond the end of the document, creating one or more additional pages in the PDF document in which the existing reflowed content is placed.

3. The method of claim 1, wherein the reflowing step for the deleted content includes causing existing content to reflow to at least one of preceding lines, paragraphs, text blocks and pages, and
when a blank page remains at the end of the PDF document due to the deletion of reflowed existing content, causing the blank page to be removed from the PDF document. 0

4. The method of claim 1, wherein the reflowing step includes:
determining that the addition and/or deletion of the content causes a word in existing content that has reflowed that can be hyphenated to reflow to a subsequent line; and
hyphenating the word so that one or more syllables of the word reside in a current line and the remaining one or more syllables of the word flow to the subsequent line.

5. The method of claim 1, wherein the content includes at least one of graphics, text, and design elements, wherein the design elements include at least one of carriage returns, section breaks, line breaks and spaces.

6. The method of claim 1, further comprising:
providing for ways to print, view, save, email and otherwise manage the resulting PDF document.

7. A computer program product for the reflowing of content in a structured portable document format (PDF) document in its native format and including one or more computer readable instructions embedded on a computer readable medium and configured to cause one or more computer processors to perform the steps of:
adding and/or deleting content in the PDF document;
reflowing content immediately following the added and/or deleted content until the end of the PDF document,
wherein the reflowing for the added content includes shifting existing content after the added content to a physical location in the PDF document immediately following the added content, and
the reflowing for the deleted content includes shifting existing content after the deleted content to a physical location in the PDF document to where the deleted content was originally located; and
displaying the resulting PDF document,
wherein the steps of adding and/or deleting of the content and the reflowing of the content are performed while the PDF document is maintained in its native format.

8. The computer program product of claim 7, wherein the reflowing step for the added content includes causing existing content to reflow to at least one of subsequent lines, paragraphs, text blocks and pages, and
when the existing content reflows to a physical location beyond the end of the document, creating one or more additional pages in the PDF document in which the existing reflowed content is placed.

9. The computer program product of claim 7, wherein the reflowing step for the deleted content includes causing existing content to reflow to at least one of preceding lines, paragraphs, text blocks and pages, and
when a blank page remains at the end of the PDF document due to the deletion of reflowed existing content, causing the blank page to be removed from the PDF document.

10. The computer program product of claim 7, wherein the reflowing step includes:
determining that the addition and/or deletion of the content causes a word in existing content that has reflowed that can be hyphenated to reflow to a subsequent line; and
hyphenating the word so that one or more syllables of the word reside in a current line and the remaining one or more syllables of the word flow to the subsequent line.

11. The computer program product of claim 7, wherein the content includes at least one of graphics, text, and design elements, wherein the design elements include at least one of carriage returns, section breaks, line breaks and spaces.

12. The computer program product of claim 7, further comprising:
providing for ways to print, view, save, email and otherwise manage the resulting PDF document.

13. A computer implemented system for the reflowing of content in a structured portable document format (PDF) document in its native format, the system comprising:
an application for adding and/or deleting content in the PDF document;
a reflow mechanism in communication with the application and configured for reflowing content immediately following the added and/or deleted content until the end of the PDF document,
wherein the reflowing for the added content includes shifting existing content after the added content to a physical location in the PDF document immediately following the added content, and
the reflowing for the deleted content includes shifting existing content after the deleted content to a physical location in the PDF document to where the deleted content was originally located; and
displaying the resulting PDF document,
wherein the adding and/or deleting of the content and the reflowing of the content are performed while the PDF document is maintained in its native format.

14. The system of claim 13, wherein the reflowing for the added content includes the reflow mechanism causes existing content to reflow to at least one of subsequent lines, paragraphs, text blocks and pages, and
when the existing content reflows to a physical location beyond the end of the document, the reflow mechanism creates one or more additional pages in the PDF document in which the existing reflowed content is placed.

15. The system of claim 13, wherein the reflowing for the deleted content includes the reflow mechanism causes existing content to reflow to at least one of preceding lines, paragraphs, text blocks and pages, and
when a blank page remains at the end of the PDF document due to the deletion of reflowed existing content, the reflow mechanism causes the blank page to be removed from the PDF document.

16. The system of claim 13, wherein the reflow mechanism determines that the addition and/or deletion of the content causes a word in existing content that has reflowed that can be hyphenated to reflow to a subsequent line, and
the reflow mechanism hyphenates the word so that one or more syllables of the word reside in a current line and the remaining one or more syllables of the word flow to the subsequent line.

17. The system of claim 13, wherein the content includes at least one of graphics, text, and design elements, and the design elements include at least one of carriage returns, section breaks, line breaks and spaces.

18. The system of claim 13, wherein the application provides for ways to print, view, save, email and otherwise manage the resulting PDF document.
